(19) United States
(12) Patent Application Publication
(10) Pub. No.: US 2018/0345789 A1
(43) Pub. Date: Dec. 6, 2018

(54) INFOTAINMENT PLAYBACK CONTROL

(71) Applicant: Faraday&Future Inc., Gardena, CA (US)

(72) Inventor: Serge Nikulin, San Jose, CA (US)

(21) Appl. No.: 15/613,095

(22) Filed: Jun. 2, 2017

Related U.S. Application Data
(60) Provisional application No. 62/345,645, filed on Jun. 3, 2016.

(51) Int. Cl. B60K 35/00; H04L 29/06

(52) U.S. Cl. CPC B60K 35/00; B60K 2350/1028; H04L 65/4084; H04L 65/60

(57) ABSTRACT

Examples of the disclosure are directed to infotainment playback control. The system can be capable of returning to a previous time in audio/video in response to one or more user inputs, one or more changes in vehicle conditions, or both. In some examples, once the user has heard or seen one or more segments beginning at the previous time, the infotainment system can return to the stop time. Returning to the stop time can be immediate, gradual, or at a fixed speed. In some examples, returning to the stop time can be automatic. In some examples, returning to the stop time can be responsive to one or more user inputs. In some examples, once the user has heard or seen one or more segments of the previous time, the infotainment system can fast-forward to a “live” time.

### CROSS-REFERENCE TO RELATED APPLICATIONS

This application claims the benefit of U.S. Provisional Application No. 62/345,645, filed Jun. 3, 2016, the entirety of which is hereby incorporated by reference.

### FIELD OF THE DISCLOSURE

This relates generally to infotainment playback control, and more particularly, to an infotainment unit capable of returning to a prior time/location of the video and/or audio.

### BACKGROUND OF THE DISCLOSURE

Vehicles, especially automobiles, increasingly include a system inside the vehicle for providing entertainment to the driver and/or passenger(s). Entertainment systems have advanced in the digital age, providing several additional features such as separate entertainment units for different vehicle passengers and wireless connections to portable electronic devices. However, existing entertainment systems are limited in their ability to rewind the video and/or audio without having to listen or see the entire previous contents of the media (e.g., the portion of the audio/video that was rewound).

### SUMMARY OF THE DISCLOSURE

Examples of the disclosure are directed to infotainment playback control. The system can be capable of returning, from a stop time, to a previous time in audio/video in response to one or more user inputs, one or more changes in vehicle conditions, or both. In some examples, once the user has heard or seen one or more segments beginning at the previous time, the infotainment system can return to the stop time. Returning to the stop time can be immediate, gradual, or at a fixed speed. In some examples, returning to the stop time can be automatic (e.g., once the end of the one or more segments has been reached). In some examples, returning to the stop time can be responsive to one or more user inputs. In some examples, once the user has heard or seen one or more segments of the previous time, the infotainment system can fast-forward to a “live” time (e.g., a time later than the stop time to allow the user to be exposed to real-time media).

### BRIEF DESCRIPTION OF THE DRAWINGS

FIG. 1A illustrates an exemplary interior compartment of a vehicle according to examples of the disclosure.

FIG. 1B illustrates an exemplary console included in an infotainment system according to examples of the disclosure.

FIG. 1C illustrates a block diagram of an exemplary infotainment system according to examples of the disclosure.

FIG. 2A illustrates an exemplary method for operating the infotainment system according to examples of the disclosure.

FIG. 2B illustrates an exemplary timing diagram according to examples of the disclosure.

FIG. 3 illustrates an exemplary method for operating the infotainment system according to examples of the disclosure.

FIG. 4 illustrates an exemplary method for operating the infotainment system according to examples of the disclosure.

FIG. 5 illustrates an exemplary system block diagram of a vehicle control system according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Entertainment systems in vehicles are often times used by the driver and/or one or more passengers while riding in the vehicle. The driver and/or one or more passengers can be listening to the radio through the speakers and/or watching a movie on a display of the entertainment system. The driver and/or one or more passengers may have missed or would like to replay a previously played video and/or audio segment. Typical entertainment systems may require a user to press the rewind button to try to seek for the previously played segment. However, the user may not be able to find the segment, may have to make multiple attempts to find the segment, and/or may have to listen or view multiple segments before reaching the previously played segment—all of which can be inefficient and can frustrate the user.

Examples of the disclosure are directed to infotainment playback control. The system can be capable of returning to a previous time in audio/video in response to one or more user inputs, one or more changes in vehicle conditions, or both. In some examples, once the user has heard or seen one or more segments beginning at the previous time, the infotainment system can return to the stop time. Returning to the stop time can be immediate, gradual, or at a fixed speed. In some examples, returning to the stop time can be automatic (e.g., once the end of the one or more segments has been reached). In some examples, returning to the stop time can be responsive to one or more user inputs, or a location as determined by a global positioning system. In some examples, once the user has heard or seen one or more segments of the previous time, the infotainment system can fast-forward to a “live” time (e.g., to allow the user to be exposed to real-time media).

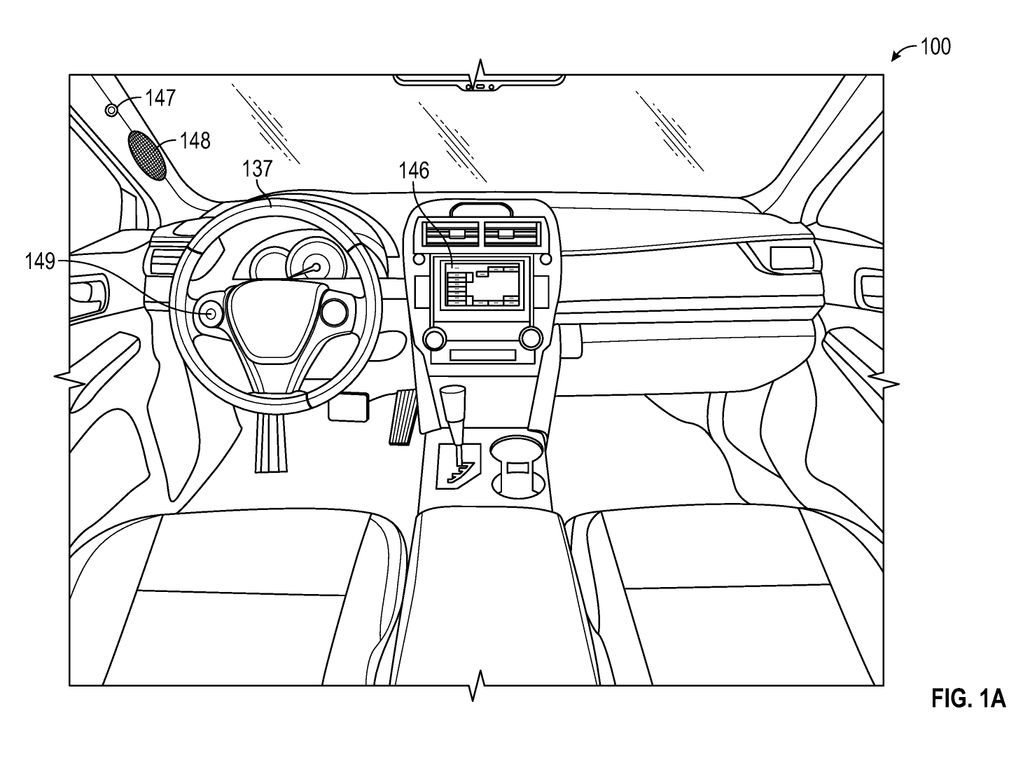

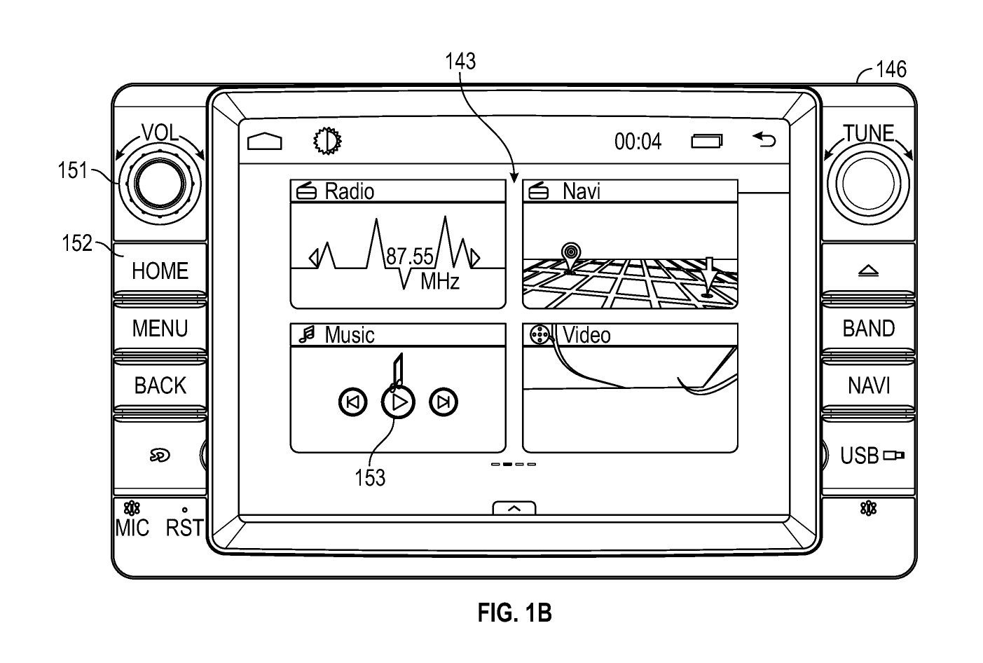

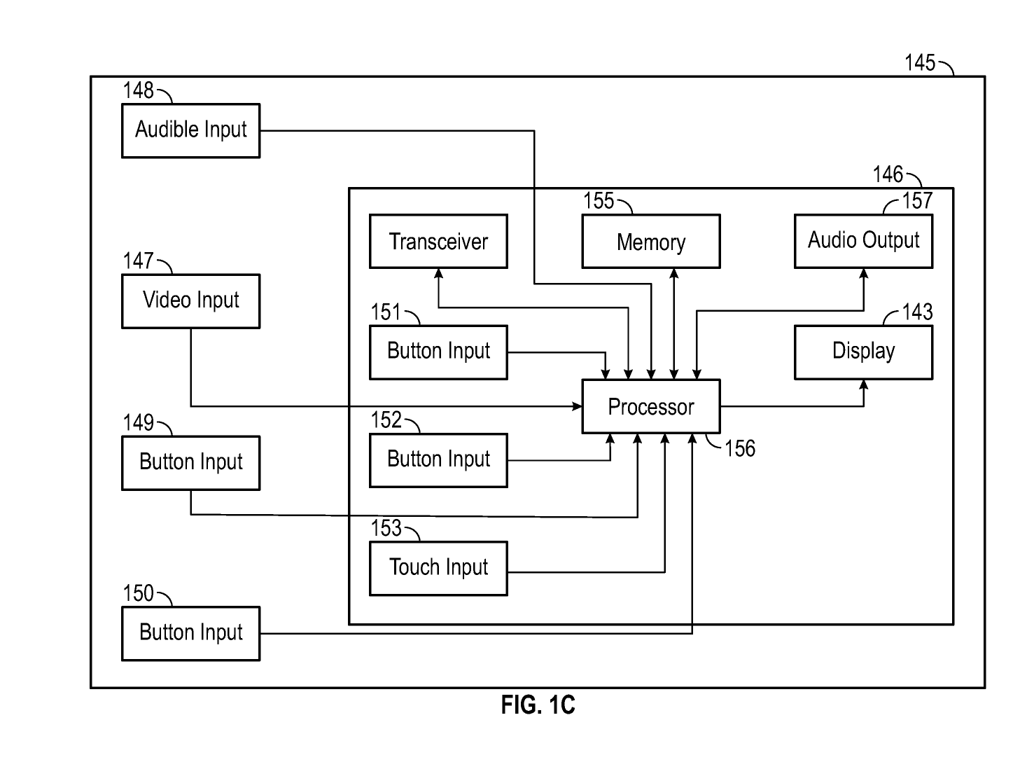

FIG. 1A illustrates an exemplary interior compartment of a vehicle according to examples of the disclosure. Interior compartment of vehicle 100 can be configured for housing one or more individuals (e.g., humans or pets) such as a driver and one or more passengers. The driver can be located in a seat in close proximity to steering wheel 137, and one or more passengers can be located in the other seats included in interior compartment of vehicle 100. Interior compartment of vehicle 100 can include an infotainment system. The infotainment system can include, but is not limited to, console 146, video input 147, audible input 148, and button input 149.

Console 146 can be configured for receiving one or more inputs and one or more outputs. The one or more inputs can be inputs received by console 146 such as force inputs on one or more buttons, touch inputs on a touch screen, and one or more commands transmitted over wireless communications. The one or more outputs can be outputs generated by console 146 such as displaying video and playing audible sounds through one or more speakers (e.g., included in console 146, in one or more components external to console 146, or both).

The one or more inputs can optionally be inputs received from components external to console 146, such as video input 147, audible input 148, and/or button input 149. Video input 147 can be capable of capturing one or more images in one or more locations of interior compartment of vehicle 100. In some examples, video input 147 can include a camera. Audible input 148 can be capable of capturing one or more audible sounds in interior compartment of vehicle 100. In some examples, audible input 148 can include a microphone. Button input 149 can receive one or more touch inputs at one or more locations on steering wheel 137. In some examples, button input 149 can include any type of mechanical or virtual button, or other type of control element. In some examples, the one or more outputs generated by console 146 can be outputs given to the driver and/or one or more passengers through components (not shown) external to console 146.

FIG. 1B illustrates an exemplary console included in an infotainment system according to examples of the disclosure. Console 146 can include a display 143, one or more button inputs, and one or more touch inputs. Display 143 can be any type of display capable of generating one or more images to be seen by the driver and/or one or more passengers. The one or more button inputs, such as button input 151 and button 152, can be any type of component capable of generating one or more signals in response to a physical change in the condition(s) of the button. For example, button input 151 can be a rotary button capable of generating one or more signals in response to a change to its angular position. The one or more signals can be received by console 146 and can indicate a level of sound intensity, for example. In some examples, button 152 can be a dome button capable of generating one or more signals in response to a change in the force applied to the button. The driver can push on the surface of the button 152, which can apply a force and can generate one or more signals in response to the applied force. The one or more signals can be received by console 146 and can indicate a selection of a feature, for example. The one or more touch inputs, such as touch input 153, can be any type of virtual button located on display 143 that can generate one or more signals in response to a contact with or a hover of an object in close proximity to a surface of display 143 (e.g., display 143 can be a touch-sensitive display). Alternatively, or in addition to the one or more touch inputs, signals received from a microphone, or electroencephalograms can control systems (e.g., a console) as described herein.

FIG. 1C illustrates a block diagram of an exemplary infotainment system according to examples of the disclosure. Infotainment system 145 can include console 146, audible input 148, video input 147, and button input 149. Infotainment system 145 can further include button input 150. Button input 150 can any type of component capable of generating one or more signals in response to a physical change in the conditions of the button. In some examples, button input 150 can be located in a component different and external to button input 149 and console 146. In some examples, button input 150 can be located in close proximity to one or more passengers. For example, button input 150 can be located in close proximity to the rear seats or in close proximity to the passenger seat in vehicle 100. In some examples, button input 150 can be operatively coupled to console 146 such that console 146 can respond to one or more input signals generated by button input 150.

Console 146 can include display 143, button input 151, button input 152, and touch input 153. Console 146 can further include audio output 157. In some examples, one or more of video input 147, audible input 148, button input 149, button input 150, button input 151, button input 152, and touch input 153 can generate the same command(s) as the other input(s). For example, a user can either push button input 151 or button input 152 to convey the same command or information to infotainment system 145. Audio output 157 can be capable of generating one or more audible sounds (e.g., audio output 157 can include one or more speakers). For example, audio output 157 can be used for playing a song or playing the sounds associated with a video being displayed by display 143.

Console 146 can further include transceiver 154. Transceiver 154 can be any type of component capable of communicating with one or more components external to infotainment system 145. The communication means of transceiver 154 can be wired or wireless communications (e.g., a peer-to-peer connection such as Bluetooth). Transceiver 154 can be coupled to a portable electronic device, for example. One or more passengers can provide input to the portable electronic device, and the portable electronic device can communicate the input to transceiver 154. In some examples, transceiver 154 can generate the same command(s) as one or more of video input 147, audible input 148, button input 149, button input 150, button input 151, button input 152, and touch input 153. For example, a user can either push button input 151 or can use a portable electronic device coupled to transceiver 154 to convey the same command or information to infotainment system 145. Transceiver 154 can generate one or more signals, for use by infotainment system 145, in response to receiving the information.

Console 146 can further include memory 155 and processor 156. Memory 155 can be any type of storage unit capable of storing information. In some examples, memory 155 can include memory internally located within console 146. In some examples, memory 155 can include any computer-readable medium such as digital optical disc (DVD) storage. Processor 156 can be coupled to memory and can retrieve information from memory 155 and/or send information to memory 155 for storage. Processor 156 can be configured to operate one or more programs, including instructions, stored in memory 155.

Processor 156 can be coupled to video input 147, audible input 148, button input 149, button input 150, transceiver 154, button input 151, button input 152, and touch input 153 to receive information from the driver and/or one or more passengers. Processor 156 can utilize the received information to perform one or more functions, such as controlling the infotainment system 145 in a manner consistent with the received information. Processor 156 can be further coupled to display 143, transceiver 154, and audio output 157 to provide one or more outputs to the driver and/or one or more passengers.

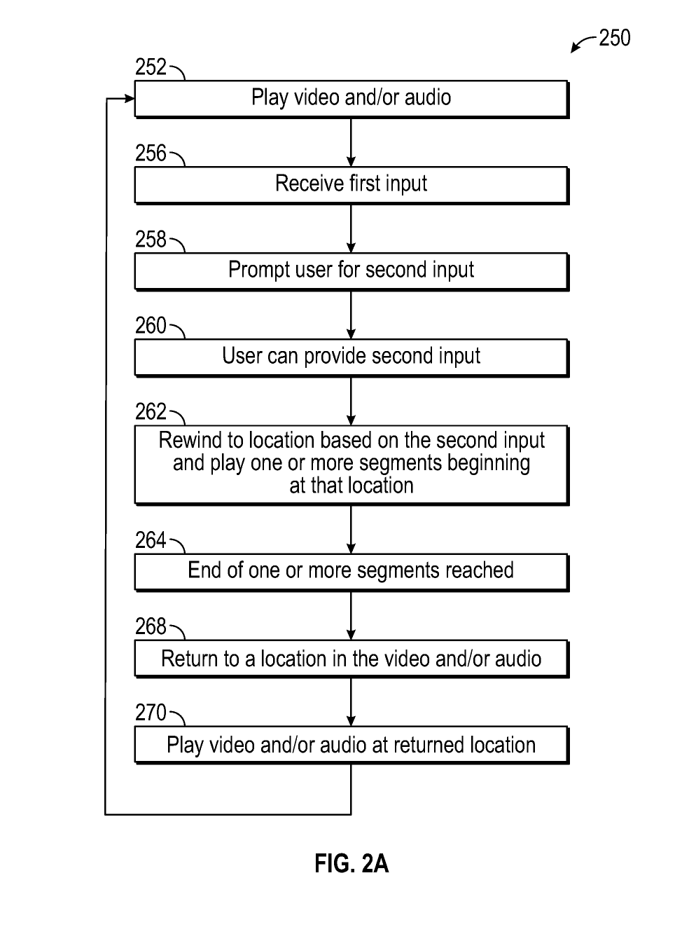

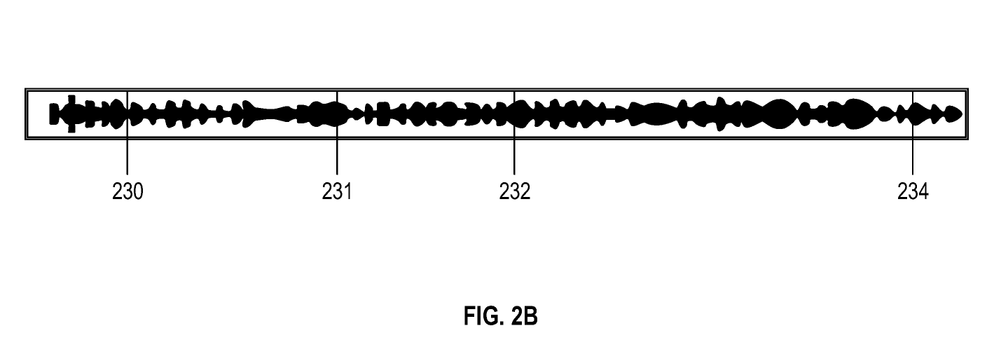

FIG. 2A illustrates an exemplary method for operating the infotainment system, and FIG. 2B illustrates an exemplary timing diagram according to examples of the disclosure. The infotainment system (e.g., infotainment system 145 illustrated in FIG. 1C) can play video and/or audio (step 252 of process 250). The video can include, but is not limited to, a movie, a sports taping, or a TV show. The audio can include, but is not limited to, an audio book, a podcast, an educational textbook, or the radio. In some examples, previously played one or more segments of video and/or audio can be stored in memory (e.g., memory 155 illustrated in FIG. 1C). A user may wish to replay one or more segments of the video and/or audio and can provide input to the infotainment system through one or more inputs for doing so (e.g., video input 147, audible input 148, button input 149, button input 150, button input 151, button input 152, and touch input 153). The infotainment system can receive the first input (step 256 of process 250) at a stop time (e.g., stop time 232 illustrated in FIG. 2B). In some examples, the infotainment system can stop playing the video and/or audio in response to the first input. For example, the user can push button input 152 (illustrated in FIG. 1B), which can generate one or more signals to the infotainment system to stop playing the video and/or audio (e.g., the infotainment system can pause the video and/or audio). In some embodiments, alternatively or in addition to receiving input from a user, a system may stop playing in response to a vehicle's location (e.g., within 0.25 miles of a destination, within 30 seconds of a destination, etc.), which may be determined based on a GPS receiver.

In any case, the infotainment system can prompt the user for a second input (step 258 of process 250). The prompt can ask the user to provide more detailed information regarding the targeted (i.e., previously played) segment. The prompt can include displaying a message on the display (e.g., display 143 illustrated in FIGS. 1B-1C) and/or sounding a message over the speakers (e.g., audio output 157 illustrated in FIG. 1C). For example, the infotainment system can display and/or play an audible message asking the user how long the user would like to rewind. In some examples, the infotainment system can display and/or play an audible message asking the user what key word the user is looking for in the audiobook.

A user can provide the second input (step 260 of process 250). In some examples, second input can include voice commands received by audible input (e.g., audible input 148 illustrated in FIG. 1A), gesture commands received by video (e.g., video input 147 illustrated in FIG. 1A), and/or button or touch commands received by buttons or touch inputs (e.g., button input 149, button input 150, button input 151, button input 152, and/or touch input 153 illustrated in FIGS. 1A-1B). In some examples, the second input can include information related to the amount of time (e.g., 30 seconds) since the previously played segment, keywords (e.g., sports team name, TV station name, transcript words, definitions, and acronyms) included in the previously played segment, key portions or images (e.g., actor, sports player, scene, facial expressions, and number of players) included in the previously played segment, and/or geographic location of the vehicle (e.g., sport team based on GPS location). In some examples, the second input can be provided by a user different from the user that gave the first input. For example, the driver can push the button input 152, and the passenger can type in 30 seconds for the rewind time. In some embodiments, a rewind time can be predetermined, such that when a user causes the system to rewind (e.g., by pressing a button, etc.), the system automatically rewinds 30 seconds. In some embodiments, a user may press a rewind button more than once, and the previous time may be the point in time where the media begins playing after a user has finished pressing the rewind button (e.g., the previous time may be determined by multiple presses of a rewind button).

In some examples, the infotainment system can provide further information related to the second input and can prompt the user for additional input based on the further information. For example, the user's second input can be a keyword (e.g., in a movie). The infotainment system may be able to find multiple locations in the movie where one or more actors or actresses spoke the keyword and can generate a list of the multiple locations (e.g., further information) on the display (e.g., display 143 illustrated in FIG. 1B). The infotainment system may then prompt the user to select (e.g., provide additional input) from the list of the multiple locations. In some examples, the first and second inputs can be a single input (e.g., a press of a button that skips backwards in the audio/video by 30 seconds).

Based on the second input (and/or additional input) information, the infotainment system can rewind (or fast-forward) to one or more locations and play one or more segments of video and/or audio beginning at the one or more locations (step 262 of process 250). For example, the infotainment system can rewind to a previous time (e.g., previous time 230 illustrated in FIG. 2B). Once the end of the one or more segments has been reached (e.g., segment end time 231 illustrated in FIG. 2B) (step 264 of process 250), the infotainment system can return to a location in the video and/or audio (step 268 of process 250). In some examples, the returned location can include the location in the video and/or audio when the first input was received (e.g., the location in the video/audio at which a driver/passenger requested the video/audio be rewound, also referred to herein as the stop time 232 illustrated in FIG. 2B). In some examples, the returned location can include a “live” point in the video/audio (e.g., a point in the media meant to occur later than the stop time; live time 234 illustrated in FIG. 2B). For example, the “live” point can include the present time for a live football game that is being broadcast over the radio (e.g., AM radio, FM radio, satellite radio, etc.). In some examples, the returned location can be based on information inputted by the user. The infotainment system can play the video and/or audio beginning at the returned location (step 270 of process 250).

The infotainment system can return to the returned location using any number of methods. For example, the system can immediately return to the returned location after receiving the third input (e.g., immediately return to the location in the audio/video when the reverse skip input was received, immediately return to a “live” point in the audio video, etc.). In some examples, the system can gradually return to the returned location by incrementally (e.g., 125%, 150%, 200%, etc.) increasing the playback speed until the returned location is reached (e.g., right after skipping back in the audio/video, the audio/video can be played back at 100% playback speed for a predetermined amount of time, after which the playback speed can be increased to 125% for a predetermined amount of time, after which the playback speed can be increased to 150% for a predetermined amount of time, and so on, until the returned location is reached).

In some examples, the system can increase the playback speed at a fixed speed (e.g., 200%) until the returned location is reached. In some examples, the playback speed can be based on the type of media (e.g., podcast, audio book, textbook), type of source (e.g., ESPN), location of the vehicle (e.g., near a sporting event), user preference (e.g., favorite sports team or local team), and/or contents of the media (e.g., big sports play) being played. For example, the infotainment system can play the previously played one or more segments at 100% speed. When the end of the one or more segments is reached, if the media is a sports taping of the user's favorite sports team, the infotainment system can play the media at 110% playback speed. If the media is a sports taping of another team, the infotainment system can play the media at 200% playback speed.

In some examples, the system can automatically fast forward. In any of these examples, the infotainment system can allow the user to listen or re-listen to the contents of one or more previously played segments without needing to replay the entire contents of the previously played media (e.g., the infotainment system can skip the media between segment end time 231 and current time 232 illustrated in FIG. 2B). In any of these examples, the infotainment system can return to the stop time (e.g., stop time 232 illustrated in FIG. 2B) or live time (e.g., live time 234 illustrated in FIG. 2B) without the user input.

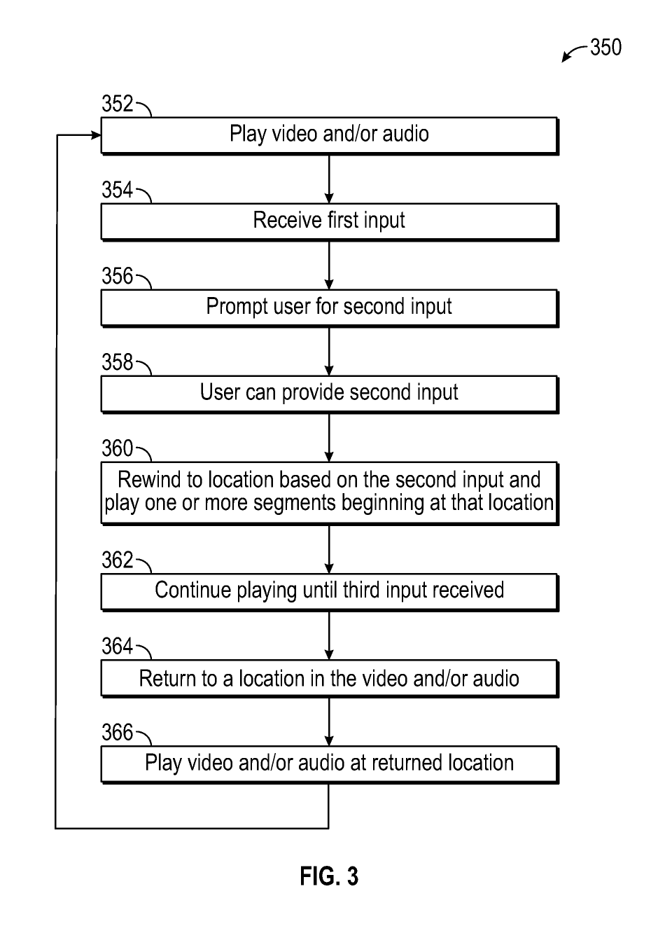

In some examples, a user can provide input when the user has completed listening or seeing the one or more previously played segments. FIG. 3 illustrates an exemplary method for operating the infotainment system according to examples of the disclosure. The infotainment system (e.g., infotainment system 145 illustrated in FIG. 1C) can play video and/or audio (step 352 of process 350). The video can include, but is not limited to, a movie, a sports taping, or a TV show. The audio can include, but is not limited to, an audio book, a podcast, an educational textbook, or the radio. In some examples, previously played one or more segments of video/audio can be stored in memory (e.g., memory 155 illustrated in FIG. 1C). A user may wish to replay one or more segments of the video and/or audio and can provide input to the infotainment system through one or more inputs for doing so (e.g., video input 147, audible input 148, button input 149, button input 150, button input 151, button input 152, and touch input 153). The infotainment system can receive the first input (step 354 of process 350) at a stop time (e.g., stop time 232 illustrated in FIG. 2B). In some examples, the infotainment system can stop playing the video and/or audio in response to the first input. For example, the user can turn button input 151 (illustrated in FIG. 1B), which can generate one or more signals to the infotainment system to stop playing the video and/or audio (e.g., the infotainment system can pause the video and/or audio).

The infotainment system can prompt the user for a second input (step 356 of process 350). The prompt can ask the user to provide more detailed information regarding the targeted (i.e., previously played) segment. The prompt can include displaying a message on the display (e.g., display 143 illustrated in FIGS. 1B-1C) and/or sounding a message over the speakers (e.g., audio output 157 illustrated in FIG. 1C). For example, the infotainment system can display and/or play an audible message asking the user how long the user would like to rewind. In some examples, the infotainment system can display and/or play an audible message asking the user what scene the user is looking for in a movie.

A user can provide the second input (step 358 of process 350). In some examples, second input can include voice commands received by audible input (e.g., audible input 148 illustrated in FIG. 1A), gesture commands received by video (e.g., video input 147 illustrated in FIG. 1A), and/or button or touch commands received by buttons or touch inputs (e.g., button input 149, button input 150, button input 151, button input 152, and/or touch input 153 illustrated in FIGS. 1A-1B). In some examples, the second input can include information related to the amount of time (e.g., 30 seconds) since the previously played segment, keywords (e.g., sports team name, TV station name, transcript words, definitions, and acronyms) included in the previously played segment, key portions or images (e.g., actor, sports player, scene, facial expressions, and number of players) included in the previously played segment, and/or geographic location of the vehicle (e.g., sport team based on GPS location). In some examples, the second input can be provided by a user different from the user that gave the first input. For example, the passenger can provide touch input (e.g., first input) on an electronic device. The electronic device can communicate the touch input to a transceiver (e.g., transceiver 154 illustrated in FIG. 1C). The driver can type (e.g., second input) in 1 minute for the rewind time. In some examples, the infotainment system can provide further information related to the second input and can prompt the user for additional input based on the further information. For example, the user's second input can be the type of sports (e.g., football or basketball). The infotainment system may be able to find live sports tapings currently being aired and can generate a list of the multiple live sports tapings (i.e., further information) on the display (e.g., display 143 illustrated in FIG. 1B). The infotainment system may then prompt the user to select (i.e., provide additional input) from the list of the multiple sports tapings. In some examples, the first and second inputs can be a single input (e.g., a press of a button that skips forwards in the video and/or audio).

Based on the second input (and/or additional input) information, the infotainment system can rewind to one or more locations (e.g., previous time 230 illustrated in FIG. 2B) and play one or more segments of video and/or audio beginning at the one or more locations (step 360 of process 350). The infotainment system can continue playing the video and/or audio until a third input is received by a user (e.g., at segment end time 231 illustrated in FIG. 2B) (step 362 of process 350). In some examples, the third input can include voice commands received by audible input (e.g., audible input 148 illustrated in FIG. 1A), gesture commands received by video (e.g., video input 147 illustrated in FIG. 1A), and/or button or touch commands received by buttons or touch inputs (e.g., button input 149, button input 150, button input 151, button input 152, and/or touch input 153 illustrated in FIGS. 1A-1B). In some examples, the third input can include information related to the amount of time (e.g., 45 seconds) since the previously played segment, keywords (e.g., sports team name, TV station name, transcript words, definitions, and acronyms) included in the previously played segment, key portions or images (e.g., actor, sports player, scene, facial expressions, and number of players) included in the previously played segment, and/or geographic location of the vehicle (e.g., sport team based on GPS location). In some examples, the third input can be provided by a user different from the user that gave the first and/or second input.

Responsive to receiving the third input, the infotainment system can return to a location in the video and/or audio (step 364 of process 350). In some examples, the returned location can include the location in the video and/or audio when the first input was received (e.g., the location in the video/audio at which a driver/passenger requested the video/audio be rewound, also referred to herein as the stop time 232 illustrated in FIG. 2B). In some examples, the returned location can include a “live” point in the video/audio (e.g., a point in the media meant to occur later than the stop time; live time 234 illustrated in FIG. 2B). For example, the “live” point can include the present time for a live football game that is being broadcast over the radio. In some examples, the returned location can be based on information inputted by the user. The infotainment system can play the video and/or audio beginning at the returned location (step 366 of process 350).

The infotainment system can return to the returned location using any number of methods. For example, the system can immediately return to the returned location after receiving the third input (e.g., immediately return to the location in the audio/video when the reverse skip input was received, immediately return to a “live” point in the audio video, etc.). In some examples, the system can gradually return to the returned location by incrementally (e.g., 125%, 150%, 200%, etc.) increasing the playback speed until the returned location is reached (e.g., right after skipping back in the audio/video, the audio/video can be played back at 100% playback speed for a predetermined amount of time, after which the playback speed can be increased to 125% for a predetermined amount of time, after which the playback speed can be increased to 150% for a predetermined amount of time, and so on, until the returned location is reached).

In some examples, the system can increase the playback speed at a fixed speed (e.g., 200%) until the returned location is reached. In some examples, the playback speed can be based on the type of media (e.g., podcast, audio book, textbook), type of source (e.g., ESPN), location of the vehicle (e.g., near a sporting event), user preference (e.g., favorite sports team or local team), and/or contents of the media (e.g., big sports play) being played. For example, the infotainment system can play the previously played one or more segments at 100% speed. When the user pushes a button, if the media includes trailers for upcoming movies, the infotainment system can play the media at 175% playback speed. If the media includes the credits and the user is interested in finding out the name of a certain actress, the infotainment system can play the media at 125% playback speed. In some examples, the system can automatically fast forward. In any of these examples, the infotainment system can allow the user to listen or re-listen to the contents of one or more previously played segments without needing to replay the entire contents of the previously played media. In any of these examples, the infotainment system can return to the stop or live time without the user input.

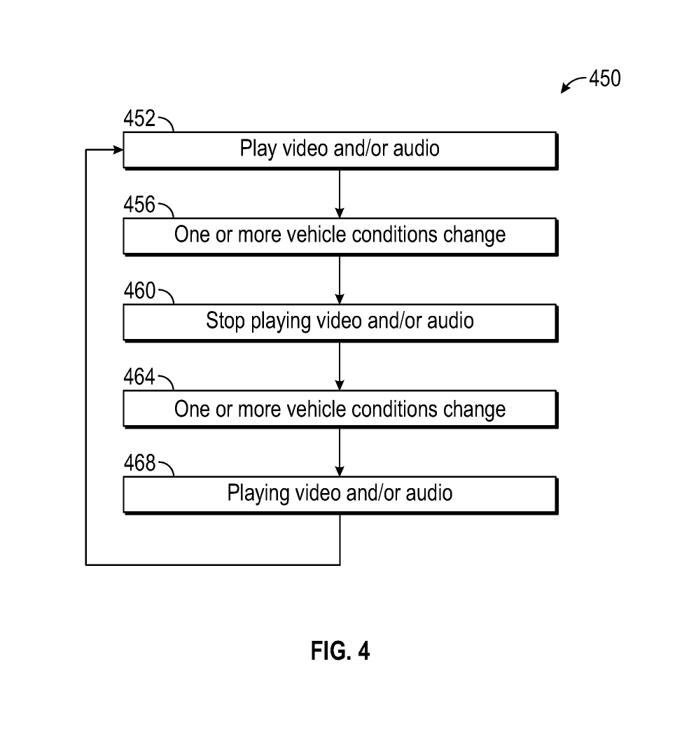

In some examples, video and/or audio playback control can be based on a change in one or more vehicle conditions. FIG. 4 illustrates an exemplary method for operating the infotainment system according to examples of the disclosure. The infotainment system (e.g., infotainment system 145 illustrated in FIG. 1C) can play video and/or audio (step 452 of process 450). The video can include, but is not limited to, a movie, a sports taping, or a TV show. The audio can include, but is not limited to, an audio book, a podcast, an educational textbook, or the radio. In some examples, previously played one or more segments of video and/or audio can be optionally stored in memory (e.g., memory 155 illustrated in FIG. 1C).

While playing the video and/or audio, one or more vehicle conditions can change (step 456 of process 450). For example, the vehicle can be parked, the vehicle can be turned off, the vehicle can be driven onto a freeway or a particular road, the vehicle can approach one or more locations (e.g., near home), and/or the vehicle can activate a garage door. In some examples, the change in vehicle conditions can be automatically detected. In some examples, the change in vehicle conditions can be input by one or more users. During any one of these instances, the driver and/or one or more passengers may not hear or absorb the segment that is being played by the infotainment system during the change in vehicle conditions. When the vehicle conditions change again (e.g., resumes operation by driving, turning back on, merging onto the freeway, or driving away from home), the infotainment system continuing to play the video and/or audio may result in the driver and/or one or more passengers missing the contents of the segment played during the change in vehicle conditions.

In response to the changed vehicle conditions, the infotainment system can stop playing the video and/or audio (e.g., at stop time 232 illustrated in FIG. 2B) (step 460 of process 450), since the driver and/or one or more passengers may not hear or absorb the segment. The infotainment system can then wait to resume playing the video and/or audio for an appropriate time in the future such as when one or more vehicle conditions change (step 464 of process 450). For example, the driver can park the vehicle (e.g., one or more vehicle conditions change), but may be focused solely on parking the car while doing so. The driver's focus on parking can prevent the driver from hearing or absorbing the segment that would have been playing while the driver was parking (or turning off the vehicle, driving the vehicle onto a particular road, etc.). At some point in time, one or more vehicle conditions that were in existence before the conditions changed (at step 456) can resume (step 464 of process 450) (e.g., the vehicle can be turned on, the vehicle can be parked, the vehicle can merge onto the freeway, etc.), and the infotainment system can resume playing the video and/or audio (e.g., continue playing the media from stop time 232 illustrated in FIG. 2B) (step 468 of process 450).

In some examples, the infotainment system can continue to play while the one or more vehicle conditions are changing (e.g., media can be playing while the driver is parking or as the vehicle is approaching a location). When the vehicle conditions stop changing (e.g., the driver has finished parking, or the vehicle has reached the location) at a stop time (e.g., stop time 232 illustrated in FIG. 2B), the infotainment system can rewind to a location (e.g., previous time 230 illustrated in FIG. 2B) in the media. When one or more vehicle conditions change (e.g., the driver starts driving, or the vehicle leaves the location), the infotainment system can play the one or more segments of video and/or audio beginning at the location (e.g., previous time 230 in FIG. 2B) in the media. For example, the infotainment system can play video and/or audio while the driver is parking the vehicle. When the driver has finished parking, the infotainment system can automatically rewind to a previous time when the driver began parking. To prevent the driver from missing the contents of one or more previously played segments (that begun at the previous time), when the driver resumes driving the vehicle, the infotainment system can play the one or more previously played segments.

In some examples, automatically rewinding to the previous time can be used to help the driver recall the contents of the previous segment after a certain time period has lapsed. In some examples, the one or more vehicle conditions changing and/or resuming can include user input. For example, before the driver begins to park the vehicle, the driver can push a button (e.g., button input 152). In some examples, the vehicle can automatically detect the condition of being parked. The button can generate one or more signals to the infotainment system (e.g., infotainment system 145) that can stop playing the video/audio. When the driver begins driving, the infotainment system 145 can resume operation or can wait for further user input before resuming operation.

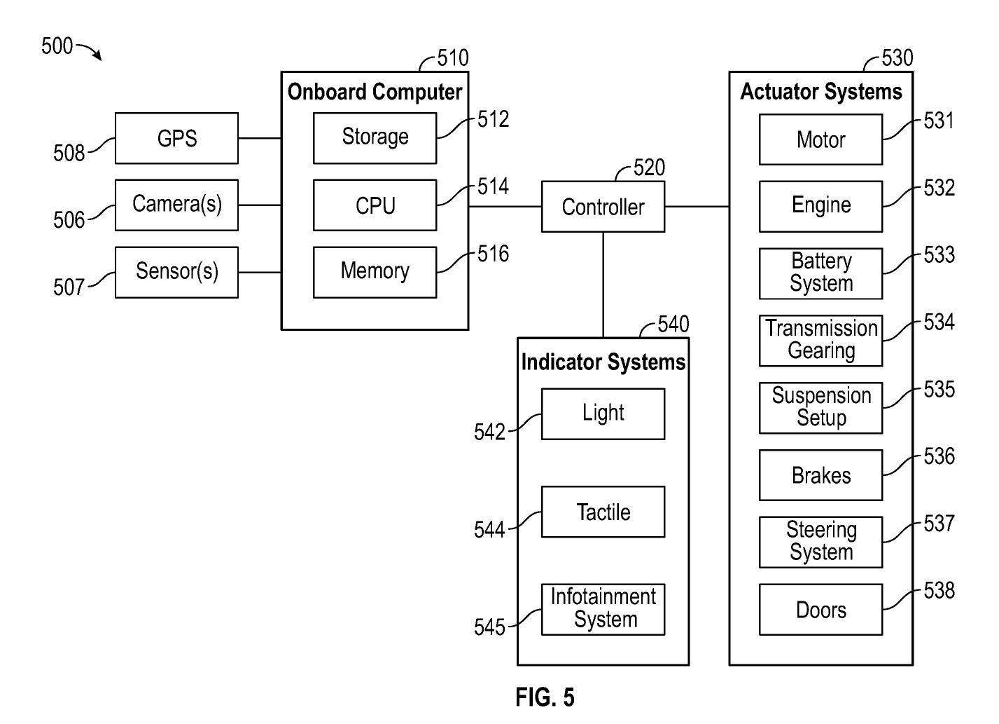

FIG. 5 illustrates an exemplary system block diagram of a vehicle control system according to examples of the disclosure. Vehicle control system 500 can perform any of the methods described with reference to FIGS. 1-4. The methods described with reference to FIGS. 1-4 can operate in any vehicle operation mode including, but not limited to, advanced driver assistance system (ADAS) mode.

System 500 can be incorporated into a vehicle, such as a consumer automobile. Other example vehicles that may incorporate the system 500 include, without limitation, airplanes, boats, motorcycles or industrial automobiles. Vehicle control system 500 can include one or more cameras 506 capable of capturing image data (e.g., video data) for determining various characteristics of the vehicle's surroundings. Vehicle control system 500 can also include one or more other sensors 507 (e.g., radar, ultrasonic, LIDAR, etc.) capable of detecting various characteristics of the vehicle's surroundings. For example, sensors 507 can be used for detecting the presence of an object. Global Positioning System (GPS) receiver 508 capable of determining the location of the vehicle.

Vehicle control system 500 can include an on-board computer 510 that is coupled to the cameras 506, sensors 507, and GPS receiver 508, and that is capable of receiving the image data from the cameras and/or outputs from the sensors 507, and the GPS receiver 508. On-board computer 510 can include storage 512, memory 516, and a processor (CPU) 514. CPU 514 can perform any of the methods described in this disclosure, including those described with reference to FIGS. 1-4. Additionally, storage 512 and/or memory 516 can store data and instructions for performing any of the methods described in this disclosure, including those described with reference to FIGS. 1-4. Storage 512 and/or memory 516 can be any non-transitory computer readable storage medium, such as a solid-state drive or a hard disk drive, among other possibilities.

The vehicle control system 500 can also include a controller 520 capable of controlling one or more aspects of vehicle operation. In some examples, the vehicle control system 500 can be connected to (e.g., via controller 520) one or more actuator systems 530 in the vehicle and one or more indicator systems 540 in the vehicle. The one or more actuator systems 530 can include, but are not limited to, a motor 531 or engine 532, battery system 533, transmission gearing 534, suspension setup 535, brakes 536, steering system 537, and door system 538. The vehicle control system 500 can control, via controller 520, one or more of these actuator systems 530 during vehicle operation; for example, to open or close one or more of the doors of the vehicle using the door actuator system 538, to control the vehicle during autonomous driving or parking operations using the motor 531 or engine 532, battery system 533, transmission gearing 534, suspension setup 535, brakes 536 and/or steering system 537, etc. The one or more indicator systems 540 can include, but are not limited to, one or more lights 542 in the vehicle, one or more tactile actuators 544 in the vehicle (e.g., as part of a steering wheel or seat in the vehicle), and/or one or more infotainment systems 545 (e.g., infotainment system 145 in FIG. 1C, as part of providing entertainment and/or information to the user). The vehicle control system 500 can control, via controller 520, one or more of these indicator systems 540 to provide indications to a user of the vehicle.

A method for playing media to an interior compartment of a vehicle is disclosed. The method can comprise: playing media to an interior compartment of a vehicle, the media including one or more of an audio and a video; at a stop time in the media, skipping to a previous time in the media responsive to one or more inputs from one or more users located in the interior compartment of the vehicle; playing one or more segments of the media to the interior compartment, the one or more segments beginning at the previous time in the media; automatically skipping to a different time in the media when an end of the one or more segments is reached, wherein the end of the one or more segments is different than the stop time; and playing the media to the interior compartment at the different time in the media. Additionally or alternatively, in some examples, the previous time in the media is based on a rewind time received from the one or more users. For example, the rewind time can be entered by a user, and/or the rewind time can be a predetermined amount of time that can be actuated by a single or multiple presses of a button (or other input). In some examples, the one or more inputs include one or more words, portions, or images, the one or more words, portions, or images included in a contents of the one or more segments. Additionally or alternatively, in some examples, the different time is the stop time. Additionally or alternatively, in some examples, the different time is a live time. Additionally or alternatively, in some examples, automatically skipping includes returning to the different time in the media when the end of the one or more segments is reached. Additionally or alternatively, in some examples, automatically skipping includes playing the media between the end of the one or more segments and the different time at a speed, the speed being incrementally increased.

A method for playing media to an interior compartment of a vehicle is disclosed. The method can comprise: playing media to an interior compartment of a vehicle, the media including one or more of an audio and a video; at a stop time in the media, skipping to a previous time in the media responsive to one or more first inputs from one or more users located in the interior compartment of the vehicle; playing one or more segments of the media to the interior compartment, the one or more segments beginning at the previous time in the media; responsive to one or more second inputs from the one or more users, skipping to the stop time in the media; and playing the media to the interior compartment at the stop time in the media. Additionally or alternatively, in some examples, skipping to the previous time in the media includes returning to the previous time in the media when the one or more second inputs are received. Additionally or alternatively, in some examples, skipping to the previous time in the media includes playing the media at a speed, the speed being incrementally increased.

A method for playing media to an interior compartment of a vehicle is disclosed. The method can comprise: playing media to an interior compartment of a vehicle, the media including one or more of an audio and a video; at a stop time in the media, ceasing playing the media responsive to a change in one or more first vehicle conditions; skipping to a previous time in the media responsive to the change in the one or more first vehicle conditions, and playing the media at the beginning of the previous time in the media to the interior compartment of the vehicle responsive to a change in one or more second vehicle conditions. Additionally or alternatively, in some examples, the change in the one or more first vehicle conditions includes the vehicle being parked, and the change in the one or more second vehicle conditions includes the vehicle being driven. Additionally or alternatively, in some examples, the change in the one or more first vehicle conditions includes the vehicle approaching a location, and the change in the one or more second vehicle conditions includes the vehicle leaving the location.

A system is disclosed. The system can comprise: one or more inputs configured to generate one or more input signals in response to a change in a condition performed by a user located in an interior compartment of a vehicle; one or more outputs configured to play media to the interior compartment of the vehicle; and a processor coupled to the one or more inputs and one or more outputs, the processor configured to: transmit one or more output signals to the one or more outputs, the one or more output signals associated with a contents of the media at a stop time, receive one or more first input signals from the one or more inputs, responsive to the one or more first input signals, automatically seek for and play one or more segments of the media beginning at a previous time, and automatically skipping to the previous time in the media when an end of the one or more segments is reached. Additionally or alternatively, in some examples, the one or more inputs include a button input or a touch input from a console. Additionally or alternatively, in some examples, the button input is located on a steering wheel. Additionally or alternatively, in some examples, the one or more inputs include one or more of a video and an audio input. Additionally or alternatively, in some examples, the one or more inputs include a button input from a component separate and distinct from a console. Additionally or alternatively, in some examples, the system further comprises: a transceiver configured to receive the one or more output signals from a component external to the system. Additionally or alternatively, in some examples, the component is a portable electronic device, and the one or more signals are transmitted to the transceiver using a peer-to-peer connection. Additionally or alternatively, in some examples, the system further comprises: memory configured to store the contents of the media associated with the different time.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method comprising:
playing media to an interior compartment of a vehicle, the media including one or more of an audio and a video;
at a stop time in the media, skipping to a previous time in the media responsive to one or more inputs from one or more users located in the interior compartment of the vehicle;
playing one or more segments of the media to the interior compartment, the one or more segments beginning at the previous time in the media;
automatically skipping to a different time in the media when an end of the one or more segments is reached, wherein the end of the one or more segments is different than the stop time; and
playing the media to the interior compartment at the different time in the media.

2. The method of claim 1, wherein the previous time in the media is based on a rewind time received from the one or more users.

3. The method of claim 1, wherein the one or more inputs include one or more words, portions, or images, the one or more words, portions, or images included in a contents of the one or more segments.

4. The method of claim 1, wherein the different time is the stop time.

5. The method of claim 1, wherein the different time is a live time.

6. The method of claim 1, wherein automatically skipping includes returning to the different time in the media when the end of the one or more segments is reached.

7. The method of claim 1, wherein automatically skipping includes playing the media between the end of the one or more segments and the different time at a speed, the speed being incrementally increased.

8. A method comprising:
playing media to an interior compartment of a vehicle, the media including one or more of an audio and a video;
at a stop time in the media, skipping to a previous time in the media responsive to one or more first inputs from one or more users located in the interior compartment of the vehicle;
playing one or more segments of the media to the interior compartment, the one or more segments beginning at the previous time in the media;
responsive to one or more second inputs from the one or more users, skipping to the stop time in the media; and
playing the media to the interior compartment at the stop time in the media.

9. The method of claim 8, wherein skipping to the previous time in the media includes returning to the previous time in the media when the one or more second inputs are received.

10. The method of claim 8, wherein skipping to the previous time in the media includes playing the media at a speed, the speed being incrementally increased.

11. A system comprising:
one or more inputs configured to generate one or more input signals in response to a change in a condition performed by a user located in an interior compartment of a vehicle;
one or more outputs configured to play media to the interior compartment of the vehicle; and
a processor coupled to the one or more inputs and one or more outputs, the processor configured to:
transmit one or more output signals to the one or more outputs, the one or more output signals associated with a contents of the media at a stop time,
receive one or more first input signals from the one or more inputs,
responsive to the one or more first input signals, automatically seek for and play one or more segments of the media beginning at a previous time, and
automatically skipping to the previous time in the media when an end of the one or more segments is reached.

12. The system of claim 11, wherein the one or more inputs include a button input or a touch input from a console.

13. The system of claim 11, wherein the button input is located on a steering wheel.

14. The system of claim 11, wherein the one or more inputs include one or more of a video and an audio input.

15. The system of claim 11, wherein the one or more inputs include a button input from a component separate and distinct from a console.

16. The system of claim 11, further comprising:
a transceiver configured to receive the one or more output signals from a component external to the system.

17. The system of claim 16, wherein the component is a portable electronic device, and the one or more signals are transmitted to the transceiver using a peer-to-peer connection.

18. The system of claim 11, further comprising:
memory configured to store the contents of the media associated with the different time.
